(19) United States
(12) Patent Application Publication
(10) Pub. No.: US 2021/0213634 A1
(43) Pub. Date: Jul. 15, 2021

(54) MULTI-PURPOSE HOLDING DEVICE AND METHOD FOR USE OF THE SAME

(71) Applicant: CLEANGRIP AS, Kongsberg (NO)

(72) Inventor: Tom Rune Stepien, Kongsberg (NO)

(21) Appl. No.: 17/058,222

(22) PCT Filed: May 21, 2019
(86) PCT No.: PCT/NO2019/050112

§ 371 Date: Nov. 24, 2020

(30) Foreign Application Priority Data
May 30, 2018 (NO) 20180751

(51) Int. Cl. B26B 29/06; A47J 43/18; A47J 47/00

(52) U.S. Cl. CPC B26B 29/063; A47J 47/00; A47J 43/18

(57) ABSTRACT

This publication relates to a profiled device (1) for holding a product, for example when slicing the product or when holding and moving a hot product or object, the profiled device (1) being provided with two opposed side parts (3), spaced apart by an intermediate part. The device (1) comprises at least one handle (2) and having at least a shape in longitudinal direction with a longitudinal profile, the device (1) having two legs or flanges (3) that may be pressed against a product or an object placed inside the device (1) by means of a person's hand placed around the object to be held. The publication also relates to use of such device for holding an object while slicing, where the device (1) is put around the object to be held and/or sliced by putting the hand around the top of the device (1) and pressing the fingers firmly against the outer surface of the legs (3) of the device (1) while the palm of the hand pressing the device (1) and the object firmly down against the supporting surface.

### THE TECHNICAL FIELD OF THE INVENTION

The present invention relates to a multi-purpose holding device suitable for hygienic or clean holding of a product in a stable and firm manner, such product being for example food products of different types. The area of use may for example be slicing of the product into slices or bits or pieces, avoiding contact between the hand of the person holding the product and the product itself, or for handling hot products.

The present invention also relate to a method for use of such device.

### BACKGROUND OF THE INVENTION

Food product surfaces, such as bread, meat or other food products to be handled and/or cut into slices or bits, using sharp knives or other sharp cutting devices, are a source of spreading viruses and bacteria, due to the porous and organic surface, and since the food has to be firmly held by the hand when slicing.

In many instances when slicing bread, a number of persons may be in contact with the same bread when slicing, in particular as part of meals in hotels or the like. When slicing bread, one hand is used to firmly grip around the bread in order to hold the bread firmly against a supporting surface in a more or less stable manner, while the other hand is used to hold the knife for slicing.

This is not hygienic, since the hand holding of the bread may be infested or contaminated by viruses, bacteria or other detrimental substances or organisms. In addition, it is a risk of cutting a flesh wound in the fingers holding the bread.

In hotels, old people's home, kindergarten, schools, cantinas or hospitals, a cloth is commonly placed over and partly around the bread in order to prevent direct contact between the hand and the bread. The cloth is moved between different types of bread and may be turned upside down or drop down on the floor and taken up and used again. The same problem may occur in an ordinary household, where different persons of the household shall slice their bread. It may be adults, kids or juveniles with a cold, sneezing with dripping nose or dirty hands that may be in direct contact with the bread to be cut, or kids coming directly in after having played, slicing the bread without having washed their hand thoroughly enough. In such case, the bacteria are easily spread and transferred amongst the family.

When slicing meat, the meat is most often very hot and in addition, the surface may be greasy and slippery, requiring use of a fork in order to fix the meat stably against the supporting surface when slicing. Repeatedly use of a fork for fixation of the slippery or greasy meat to the supporting surface may often result in difficulties in obtaining equal slices and/or many penetrations in the upper meat surface caused by the teeth of the fork, resulting in uneven slices or disintegration of the piece of meat. Moreover, when handling greasy meat the fat tends to stick to the fingers and hand, requiring repeatedly need for cleaning and washing the hands before touching other objects.

WO 2007/085103 discloses a holder for use when slicing bread. The holder has a handle which is connected by means of a connecting part to a cover, to which a plurality of supporting legs are attached. To hold an object in position, the holder is held at the handle and put onto the object to be held.

U.S. Pat. No. 1,729,624 discloses a U-shaped slicing device comprising a yoke-shaped body to be mounted upon and partially encircling a product to be sliced, and means for guiding the blade of the knife over the surface of one end of the body in cutting a slice of the product. The slicing device is also provided with a handle, rigidly fixed to the device for gripping during slicing. According to this device, the hand holds a grip around a handle itself and is not in contact with the bread to be sliced, thus the bread is not sufficiently supported in a stable manner.

U.S. Pat. No. 5,287,784 discloses a bread slicing device designed specifically for use with cylindrical shaped loaves produced by home automatic bread baking machines. The device consists of two parts: a clear cover with built in knife holder and a bread slicing holder. The bread slicing holder is rigid, monolithic in construction, featuring two opposing parallel slicing guide side walls which extend vertically from the base of the unit along two lateral outside edges, facing upwards when slicing. The lower two-thirds of the side walls interior surfaces are concave forming with the concave bottom a tapered sharply textured cylindrical cavity. Bread is inserted into slicing holder by way of a wedged shaped entry chute. The chute momentarily compresses the bread as it is inserted into the top of the bread slicing holder. Bread loaf then expands, firmly securing it into the cylindrical cavity. The slicing guide side walls are divided by a series of evenly spaced parallel vertical slots. These slots guide the cutting implement permitting accurate and consistent slices to be produced.

It is therefore a need for a device that is hygienic, where the possibility of direct contact with a gripping and holding hand and the product to be held is eliminated, or at least substantially reduced, and also reducing the cutting risk for cuts or flesh wounds in the fingers or the holding hand.

### SUMMARY OF THE INVENTION

The invention is based on the principle of using a thin, flexible or pliable sheet, that easily may adapt to or may partly be wrapped around the contour of the product to be held or handled and preferably also easily secure a firm grip around the product during handling. Moreover, the present invention is based on the principle of avoiding direct and/or contaminating contact between a person's hands and the food product to be handled, thus isolating the product from a direct hand touch and still achieving a firm grip around the product to be held.

It is a main object of the present invention to provide a multi-purpose holding device that for example may be used for slicing bread, baguettes, meat, roast beef and the like, requiring slicing into for example thin, evenly cut slices; for handling hot food, and in particular, but not exclusively hot meat or hot objects such as for example baking tray; or for handling hot objects such as bred or steaks, taken directly out from the oven, or for handling hot objects such as frying pan or baking tray.

It is an object of the present invention to provide a product for handling food where the possibility of contaminating or spreading bacteria or viruses from a person's hands to the product is eliminated or at least substantially reduces.

It is another object of the invention to eliminate or at least substantially reduce the risk for causing injury or cuts when slicing a product with a sharp cutting device.

Yet another object of the invention is to provide a multi-purpose device for holding and carrying object, such as hot products or products prone to being contaminated by bacteria and viruses.

A further object of the invention is to provide a flexible and pliable holder configured to easily adapt to the form of the object to be held and where the hand of the holder easily may hold around the object, all in accordance with the physiological build-up of a hand, easing the handgrip around the object to be held.

Another object of the present invention is to provide a device where the objects to be sliced are visible through the device.

Another object of the invention is to provide a hand held device provided with a certain degree of form stability, providing a certain inherent resistance against easily changed shape.

A still further object of the invention is to provide a device for holding products, ensuring a form and non-slippery holding effect,

Typical areas of use may for example be handling hot food, for example transferring the food from a frying pan or an oven to a cutting plate; cutting or slicing baguettes; use as an isolating holding device for taking out a hot frying pan or baking tray out of the oven; taking out hot bread or a steak from the oven; or slicing a steak or the like.

The objects specified is achieved by use of a device as further defined by the independent claim, while, embodiments, variants or alternatives are defined by the dependent claims.

According to the present invention it is provided a profiled device for holding a product, for example when slicing the product or when holding and moving a hot product or device, the profiled device being provided with an intermediate part and two opposed side parts, spaced apart by and extending down from the intermediate part forming a more or less elongated U- or V-shaped body extending in a elongate longitudinal direction with a longitudinal profile. The device comprises preferably one or more handles or alternatively two or more handles. The profile has two legs or flanges that may be pressed against an object placed inside the device by means of a person's hand placed around the object to be held.

The holder may be in the form of an elongate profile where the profile is provided with two long pliable and flexible surfaces that may be pressed by the holding hand into firm contact with an object arranged between the two sides. The grip around the object may be obtained by putting the hand through an opening in the handle, allowing the fingers and the palm of the hand to provide the grip. The inner surfaces may be provided with a number of outwards protrusions or ribs extending in a crosswise direction of the elongated holder.

According to an embodiment, the profile may be extruded of a polymer containing anti-septic particles, for example silver particles. Moreover, the profile may be composed of plastic materials having different properties, co-extruded with a stiffer material in the bottom of the U-shaped profile and a softer material in both legs. Alternatively or in addition, the holding device may be provided with stiffening ribs extending in an orthogonal direction with respect to the longitudinal direction of the object to be held.

According to yet another embodiment, parts of or the entire device is made of a transparent material. Moreover, the length of the device in respect to the inner opening of the handle may be such that the hand is prevented for being exposed to risk for flesh wound during slicing.

According to another embodiment, the legs of the profiles at the external surface at each end may be formed with a pocket for housing the fingertips, such that the inner surface towards the object to be sliced may be prevented from being contaminated by the fingers, also in case the device unintentionally drops down on the floor.

According to a variant, the handle is dimensioned and formed in such way that the fingers and at least a part of the palm of the hand may be threaded through the opening of the handle either on top or on both sides. It should be appreciated although handles are shown either on top of the device or at the free ends of the legs, it should be noted that the handle instead may be offset in a sideways direction instead of being arranged o the top as disclosed.

The handle(s) may form an integrated part of the profile or device and may according to yet another embodiment form an angle with the longitudinal direction of the holder, adapted to anatomical build-up of a hand when holding an object. Such angle mat for example be 30°

The invention also relates to a method for holding a product during slicing. The device used is put around the object to be held and/or sliced by putting the hand around the top of the device and pressing the fingers firmly against the outer surface of the legs of the device while the palm of the hand, and pressing the device and the object firmly down against the supporting surface.

By using a device according to the invention spreading of bacteria and viruses through handling of food and other object is at least substantially reduced, since the food will not be in direct contact with the hand holding the product.

Moreover, the risk of causing flesh wounds or cuts during slicing of the food is at least substantially reduced.

The length of the legs may be configured in such way that the length of the legs is adapted to the height or cross sectional shape of the product to be held.

### SHORT DESCRIPTION OF THE DRAWINGS

In the following, embodiments shall be described in conjunction with the attached drawings, wherein:

FIG. 1 shows schematically and in perspective an embodiment of the present invention suited for fixing a bread or a steak or meat to be sliced to a supporting surface;

FIG. 2 shows schematically an end view of the device shown in perspective in FIG. 1;

FIG. 3 shows schematically a side view of the device shown in perspective in FIG. 1; and

FIG. 4 shows schematically and in perspective another embodiment of a device according to the invention.

### DETAILED DESCRIPTION OF EMBODIMENTS OF THE INVENTION

Below, embodiments of the invention shall be described in further details, referring to the attached drawings, The Figures show a few embodiments of the invention. It should be appreciated, however, that the invention is not limited to the embodiments shown, but are defined by the attached patent claims. Moreover, elements from one embodiment may be incorporated into any of the other embodiment, unless it is specifically specified to the contrary.

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to freezing of biomass or seafood on board a fishing vessel, which may be used for catching i.e. pelagic fish to be frozen directly without being intermediate stored for example at line fishing vessels.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

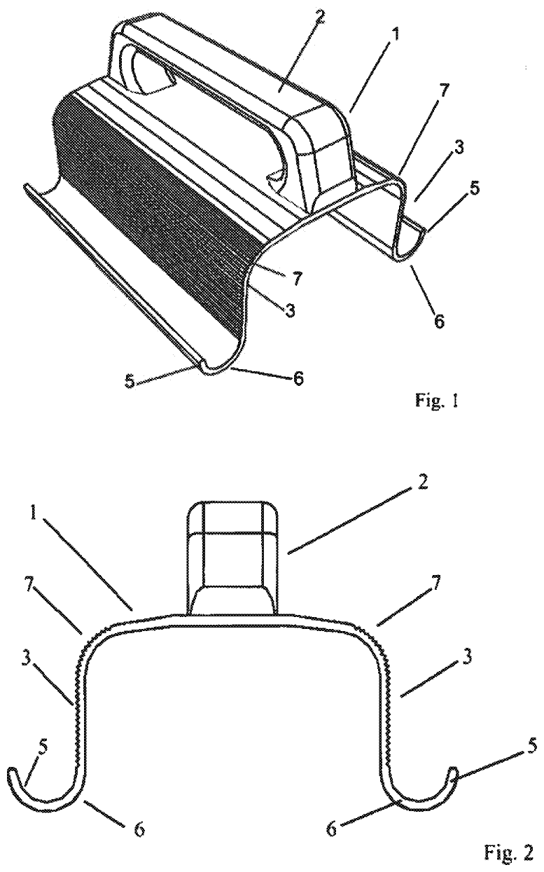

FIG. 1 shows schematically and in perspective an elongated device 1 preferably with a uniform general body in longitudinal direction, suitable for fixing a bread (not shown) to a supporting surface (not shown). The supporting surface may for example be a breadboard. As indicated in the Figure, the device 1 may have a general, more or less U-shape, more or less adapted to the cross-sectional shape of the bread. The device 1 is made of a thin, pliable and flexible material and may at the outer surface of the bottom region of the U-shape be provided with a handle 2 in a form of a looped or U-shaped body with an opening 4, allowing the user to put the hand with of the fingers through the opening 4, while the thumb or the palm of the hand remains of the opposite side, enabling a grip around the device 1 and the product to be held at the bottom of the U-shaped profile, and consequently around the object within the U-shaped device. In this way the hand will have a firm grip around the product and by providing a downwards pressure onto the supporting operation a firm fixture of the object against the supporting surface is provided.

Since the device 1 at least along parts, is pliable and flexible, then the device may more easily or readily take the shape of the object to be held.

The material used may be of a suitable plastic material, for example containing an anti-septic material, such as for example silver, providing both an inner and outer hygienic surface, not contaminating the object, goods, or product to be held and not transferring bacteria or viruses to the next user holding or using the device 1.

The device 1 comprises a main elongated body, preferably of a plastic material and with a preferably uniform U-shaped cross sectional shape in longitudinal direction, suitable for being extruded. The body comprising two legs 3 spaced apart where one end of the legs 3 are connected to an intermediate part, the three parts forming a monolithic or unitary body. The interconnection between the one end of each leg 3 and the intermediate part may be curved or arced transition 7. It should be appreciated that the free end of each of the two legs 3 of the U-shaped body may be provided with an outwards projecting and upwards projecting flipped ends 5, the transition 6 between the legs 3 and the upwards extending flips 5 being curved or arced. The purpose of this arced part to the enhance support against the supporting surface and to eliminate, or at substantially reduce the possibility of human contact with the supporting surface or the hand-held object, inside the U-shaped device 1.

Since the device 1 is flexible and pliable, shaped as an elongate U- or V-shaped profile 1, both the two legs 3 of the U-profile 1 may be pressed in towards the object to be held by the holding hand, such as for example a bread or a piece of meat (not shown), until a firm grip around the object is obtained, with the hand placed through the opening 4 of the handle 2 and with a hand grip on both sides of the U-shaped profile 1.

The embodiment disclosed is based on use of a more or less U-shaped profile 1, where the closed, intermediate part of the U-shaped profile 1 may have a more or less flat part in the area for the attached handle 2, or a curved transition part 7, while the legs 3 may for example project straight or slightly angled in downwards and outwards direction from the closed end part of the U-shaped profile.

According to one alternative a part of the closed part of the U-shaped profile 1, and/or a part of the outwardly extending legs 3 may be less flexible than the transition parts between the closed end and the stiffer leg parts.

According to one embodiment the present invention may be formed by a suitable material, dimensioned and configured to obtain the hand gripping effects for firmly holding an object. Such material may for example be anti-bacterial silicon rubber and the shape of the device may also have any other suitable shape than a U-profile in longitudinal direction, as long as the intended purposes are fulfilled.

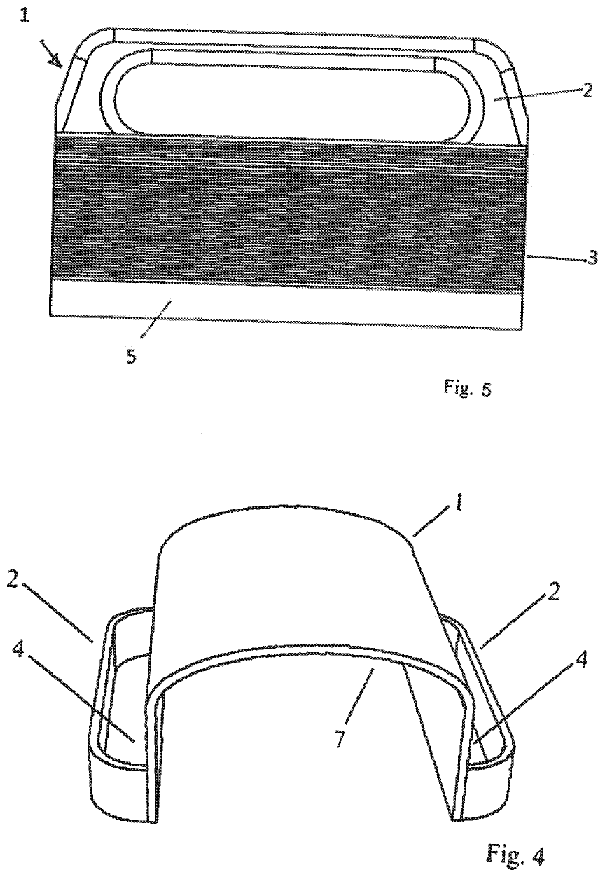

As shown in FIG. 1 the device may be provided with a handle 2 arranged on the outer surface of the closed end of the profile, while according to the embodiment shown in FIG. 4, the device is provided with a closed handle 2 at outer surface of both of the free ends of the profile. In the latter embodiment, the free ends of the legs are not provided with the curved lower end 5 and the flip 5, as disclosed in FIG. 1, the two handles 2 of FIG. 4 serving more or less the same purposes as the flip 5 ends of FIG. 1. The handles shown in FIG. 4, may prevent the fingers from being exposed to the sharp edge of the cutting knife. In addition, the free end of the legs according to this embodiment provides a more stiff and rigid free end of the legs.

The handle may be aligned with the main longitudinal direction of the holder or form an angle with said longitudinal direction.

By providing the device 1 with one or more handles 2, enabling a hand to be introduced I between the handle 2 and the device 1, makes the device 1 easy to be lifted and moved from one object to another. With a hand introduced under the handle with fingers on both side of the profile 1, provides the required clamping forces on the object to be lifted and/or sliced, thus securing a sufficient fixture of the object and also a sufficient pressure against the supporting surface.

If the device 1 according to the invention generally is made of a more stiff, rigid and less pliable or flexible material, the transition part between the closed part of the device 1 and the legs 3 may be provided with a hinged transition made of a more flexible and pliable material and/or provided with one or more thinner section extending in longitudinal direction in the transition zone. In such case the bending effect may mainly be obtain by bending in the curved upper, transition part 7 of the holder.

If the material chosen for the device is a non-elastic or pliable material, the device may be provided with one or more section allowing bending and compressing or squeezing the device around the object, said section preferably being in the transition zone between the legs and the transverse part, interconnecting one end of each leg. Such hinged part may be made of a softer or more bendable material, or may comprise one or more parallel lines in longitudinal direction of the device with less thickness, forming a bending line. Such art may be co-extruded I with the remaining part of the device during manufacturing.

When moving the device to a new product to be held, the clamping force introduces by the hand holding the device is eased, relieving the compressive force on the object. This allows for a reduced pressure exerted on to the product. In such case the holding hand can be lifted off, moving the device to another object to be sliced.

The U-shape of the device secures that the inner surface of the device, if and when dropped to the floor, will not be in contaminated contact with the floor.

By using two different polymers, one type for obtaining the required flexibility in parts of the device intended to be more flexible and one for obtaining a stiffer and more rigid handle region of the device, i.e. by for example co-extrusion, a multi-purpose holding device to be placed around the product to be firmly held enabling in addition a firm grip, is provided. Consequently a firm grip around the product to be held may be obtained by allowing the fingers to press firmly the device against the product to be held, the palm of the hand pressing firmly the device and the food to be sliced down onto the supporting surface, stably and firmly fixing the food against the supporting surface.

The stiffer and more rigid part of the device 1 may be formed of a more transparent polymer, enabling the person to observe the product to be sliced. The polymers used may include particles of an anti-septic character, such as for example small and minute silver particles, ref. https://www.plastnet.se/article/view/520130/ciba_satsar_pa_bakteriedodande_plast, The purpose of this feature is to prevent spreading bacteria due to use of the device itself.

The handle 2 may be formed of a plastic or wooden material, where both ends may be provided with a guiding device, serving as a guiding surface for the knife. The handle may be glued or bolted to the rigid part of the device. The surface of the device may also have printed the trademark or other decorations or text.

According to another embodiment of the invention, the central handle may be offset to one side of a longitudinal plane of symmetry extending lengthwise through the holder. In addition or instead, the central handle and its opening may be arranged in a skewed position in respect to the longitudinal axis or longitudinal plane of symmetry of the device.

FIG. 2 shows schematically an end vie of the device shown in perspective in FIG. 1, while FIG. 3 shows schematically a side view of the device shown in perspective in FIG. 1. As shown, the part with the handle 2 is relatively flat, It should be appreciated, however, that this part may have a shape closer to V-shaped or may be convex in an upwards direction. Moreover, the Figure indicates that this portion has a thicker part, extending sideways on both side of the handle 2, while the vertical legs 3 are thinner and may in addition as an alternative, be provided with tiny ribs or the like to secure a better grip and/or enhance the flexibility and bendability of the device 1. The purpose of the flips is to provide a better support on the supporting surface and also protection and against flesh wounds together with reduce the possibilities of finger contact with the surface intended to face towards the product be held.

FIG. 4 shows schematically and in perspective another embodiment of a device according to the invention. As indicated, the device 1 is provided with a handle 2 at each free end of the legs 3. In addition the upper surface is arced,′

The holding device may be provided with stiffening ribs extending in an orthogonal direction with respect to the longitudinal direction of device and the object to be held.

In addition to possible non-slippery surface arranged on the side of the holder facing the product to be held, the surface against which the holders hand is resting may also be provided with a contour or texture that avoid unintentional slippery of the hand, even with a greasy hand or surface.

| | |
|---|---|
| 1 | Flexible holder for objects |
| 2 | Handle |
| 3 | Legs |
| 4 | Opening in handle |
| 5 | Flip |
| 6 | Lower transition zone |
| 7 | Upper transition zone |

1. A profiled device for holding an object when slicing the object or when holding and moving the object, the profiled device comprising:
two opposed side parts spaced apart by and connected to an intermediate part, wherein:
the device comprises at least one handle and has at least a shape in longitudinal direction with a longitudinal profile, and
the device has two legs or flanges forming a monolithic or unitary body with the intermediate part, wherein the two legs or flanges are pliable and flexible to be pressed against the object placed inside the device by means of a person's hand placed around the object.

2. The device according to claim 1, wherein the device is extruded of a polymer containing anti-septic particles.

3. The device according to claim 1, wherein the device is co-extruded with a stiffer material in the bottom of the profile and a softer material in both legs.

4. The device (1) according to claim 1, wherein part of the device is made of a transparent material.

5. The device according to claim 1, wherein the length of the device with respect to the inner opening of the handle is such that the hand is prevented from being exposed to risk of flesh wounds during slicing.

6. The device according to claim 1, wherein the legs of the device are formed with a pocket for housing the finger tips, such that the inner surface of the object to be sliced is prevented from being contaminated by the fingers or in case the device unintentionally drops down on a floor.

7. The device according to claim 1, wherein the fingers and part of the hand are threaded through the opening in the handle on both sides.

8. The device according to claim 1, wherein the handle forms an integrated part of the profile.

9. The device according to claim 1, wherein the handle is offset to one side of a longitudinal plane of symmetry extending lengthwise through the device.

10. The device according to claim 1, wherein at least one of the inner and outer surface is provided with an anti-slippery texture or shape.

11. A method for holding the object of claim 1, during slicing, wherein the device is put around the object to be sliced by putting the hand around the top of the device and pressing the fingers firmly against the outer surface of the legs of the device, the finger tips being positioned within an externally arranged pocket at the lower end of the for housing the fingertips, formed at the ends of the side parts, while the palm of the hand pressing the device and the object firmly down against the supporting surface.

12. The device according to claim 6, wherein the fingers and part of the hand are threaded through the opening in the handle on both sides.

13. The device according to claim 6, wherein at least one of the inner and outer surface is provided with an anti-slippery texture or shape.
